(19) United States
(12) Patent Application Publication
(10) Pub. No.: US 2026/0190141 A1
(43) Pub. Date: Jul. 2, 2026

(54) SERVICE-AWARE REAL-TIME DYNAMIC BANDWIDTH SELECTION

(71) Applicant: Cisco Technology, Inc., San Jose, CA (US)

(72) Inventors: Brian D. HART, Sunnyvale, CA (US); Vishal S. DESAI, San Jose, CA (US); Malcolm M. SMITH, Richardson, TX (US)

(21) Appl. No.: 19/281,562

(22) Filed: Jul. 26, 2025

Related U.S. Application Data
(60) Provisional application No. 63/740,650, filed on Dec. 31, 2024.

(51) Int. Cl. H04W 74/0808; H04W 88/08

(52) U.S. Cl. CPC H04W 74/0808; H04W 88/08

(57) ABSTRACT

Techniques and apparatus for managing at least one client stations (STAs) within a wireless network are described. An example technique includes receiving a request from, or anticipating a request by, the at least on STA for an expansion of bandwidth resources. A determination is made regarding constraints and the feasibility of the expansion of bandwidth resources based on target parameters. In response to the determination, expanding bandwidth resources of at least one access point of the one or more access points within the wireless network.

### CROSS-REFERENCE TO RELATED APPLICATIONS

This application claims benefit of co-pending U.S. provisional patent application Ser. No. 63/740,650 filed Dec. 31, 2024. The aforementioned related patent application is herein incorporated by reference in its entirety.

### TECHNICAL FIELD

Embodiments presented in this disclosure generally relate to wireless communications. More specifically, embodiments disclosed herein relate to systems and techniques for dynamically aligning wireless network capacity to fluctuating user demand.

### BACKGROUND

Enterprise Wi-Fi networks often suffer from extreme congestion, stalled connections, and degraded performance during periods of high traffic load such as conferences, meetings, and other scheduled events. Dedicated Access Points (APs) become overwhelmed by the surge of bandwidth-hungry clients, leading to excessive lag, packet loss, and an inability to support critical applications. However, outside of these predictable higher-usage periods, the same APs remain drastically underutilized despite having unused airtime and capacity to handle additional clients and traffic. This results in highly inefficient wireless resource allocation, with intervals of severe congestion alternating with idle excess capacity. While enterprise Wi-Fi solutions can provide visibility into changing network usage, they lack intelligent coordination mechanisms to dynamically align Wi-Fi capacity to fluctuating user demand.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a schematic block diagram of a wireless local networking system, according to certain embodiments.

FIG. 2 illustrates a conceptual network diagram of various environments where a network management logic may operate on a plurality of network devices, according to certain embodiments.

FIG. 3 is a flowchart depicting a process for committing service-aware dynamic bandwidth transmissions, according to certain embodiments.

FIG. 4 is a flowchart depicting a process for committing service-aware dynamic bandwidth transmissions under general terms or specific trigger frames, according to certain embodiments.

FIG. 5 illustrates a conceptual block diagram of a device suitable for configuration with a network management logic, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure, A computer-implemented method for managing at least one client station (STA) within a wireless network, the computer-implemented method performed by a computing device and includes receiving a request from, or anticipating a request by, the at least one STA for an expansion of bandwidth resources; determining constraint and feasibility of the expansion of bandwidth resources, based on target parameters; and expanding bandwidth resources of at least one access point of one or more access points within the wireless network.

In another embodiment, a computer-implemented method for wireless communications performed by a first access point (AP) of a plurality of APs, the computer-implemented method includes transmitting a schedule to a client station (STA) to indicate bandwidth transmission opportunities, wherein bandwidth transmission opportunities are time periods that the first AP is operating at a wide bandwidth mode; receiving a request from the STA to perform services during bandwidth transmission opportunities responsive to transmitting the schedule; coordinating an expansion of bandwidth resources between neighboring APs of the plurality of APs relative to the first AP; and expanding bandwidth resources of the first AP according to the schedule, wherein the first AP is the AP that services the STA.

In yet another embodiment, a first access point (AP) multilink device (MLD) includes one or more memories collectively storing instructions; and one or more processors communicatively coupled to the one or more memories, the one or more processors being individually or collectively configured to execute the instructions to cause the first AP or affiliated AP of an AP MLD (hereafter AP) to perform an operation includes transmitting a schedule to a client station (STA) to indicate bandwidth transmission opportunities, wherein bandwidth transmission opportunities are time periods that the first AP is operating at a wide bandwidth mode; receiving a request for an expansion of bandwidth resources from the STA, wherein the request lists one or more target parameters associated with a service being performed by the STA; coordinating an expansion of bandwidth resources between neighboring APs relative to the first AP; and expanding bandwidth resources of the first AP, wherein the first AP is the AP that services the STA.

### Example Embodiments

While enterprise Wi-Fi solutions can provide visibility into changing network usage, they typically lack intelligent coordination mechanisms to dynamically align Wi-Fi capacity to fluctuating user demand. Embodiments described herein implement service-awareness to the Real-Time Dynamic Bandwidth Switching (RT-DBS) also known as Dynamic Bandwidth Expansion (DBE) to expand capacity during usage surges. Embodiments described herein include RT-DBS activation based on predictive bandwidth requirements. Intelligent coordination mechanisms are described in various embodiments herein to dynamically align Wi-Fi capacity to fluctuating user demand. Certain embodiments can utilize an innovative system to optimize enterprise Wi-Fi performance using RT-DBS implementing service-awareness to expand capacity when predicting usage surges.

In many embodiments, various systems, methods, and modules can be utilized. In certain embodiments, a system can perform traffic forecasting based on various data. The system can ingest real-time data such as scheduled conferences, meetings, location analytics, and historical network usage patterns. This data may then be fed into one or more machine learning models based on generalized linear regression to correlate past usage trends with meeting attributes like timing, location, room capacity, number of attendees, attendee devices, meeting type, etc. Periodic seasonal patterns can be modelled by having the model learn coefficients associated with day of week, month, and holiday effects. The trained model can then be used to predict future expected traffic volumes and congestion levels for each access point's (AP's) basic service set identification (BSSID) on a per-radio basis, given information about scheduled events in those spaces covered by that AP. For a given AP BSSID at any point in the prediction horizon, the forecast can provide the expected number of clients that will be associated, the aggregate bandwidth demand across those clients, the distribution across traffic types (video, VoIP, HTTP etc.), the expected congestion level (percentage of airtime utilization), or any combination thereof. These predictions can be performed independently for each radio supported by the AP.

In certain embodiments, a multi-AP coordination optimization can be utilized. The forecasted traffic demands can be used to perform predictive optimization of Multi-AP Coordination (MAPC) configurations across APs to best match anticipated loads. Various embodiments described herein can utilize AP Groupings. The system can use graph-based spectral clustering between APs to divide them into coordination groups (CGs) suitable for spatial reuse given their RF neighborhood relationships. These CGs determine sets of APs that can concurrently transmit without excessive interference enabling spatial reuse. Alternatively, each AP can make agreements with nearby APs and form coordination groups dynamically wherein APs or their BSSs that are outside the CG, if they were to transmit, might yet generate excessive interference and so CSMA/CA techniques may be used to limit the likelihood and impact of this.

The consumption of high-bandwidth and real time applications constitutes a massive challenge for operators and network companies to deliver these contents to end users. Beyond traditional video streaming consumption, cloud gaming, virtual reality (VR) and augmented reality (AR) are rapidly becoming more and more popular, hence further contributing to and increasing the demand of interactive and delay-sensitive content.

To address this, Wi-Fi networks are constantly evolving to handle the increasing demands of these applications in terms of throughput and/or latency, but also the increasing number of users and the traffic volume on the Internet. AP densification (i.e., covering the same area with a high number of APs) has been the natural response to cope with such situations. This approach allows stations to benefit from high Signal-to-Noise (SNR) levels, as they are close to their serving APs, resulting in the use of high-transmission rates. However, when the number of co-located APs is high, the limited number of frequency channels may result in detrimental high contention and interference levels, as well as impact the ability of the Wi-Fi networks to provide a reliable service. A solution to mitigate the high contention levels in dense Wi-Fi deployments is to coordinate transmissions from the set of overlapping APs.

To support such an objective, certain MAPC frameworks allow APs to share time, frequency and/or spatial resources in a controlled manner, alleviating Overlapping Basic Service Set (OBSS) contention, and enabling the implementation of WLAN-level scheduling mechanisms. MAPC aims to improve the overall network performance by allowing APs to share time, frequency and/or spatial resources in a coordinated way, thus alleviating inter-AP contention and enabling new multi-AP channel access strategies.

In wireless networking, a TXOP, or Transmission Opportunity, refers to a time interval during which a wireless station or device has the exclusive right to transmit data over the wireless medium. It is a concept associated with the IEEE 802.11 standard, commonly known as Wi-Fi. The TXOP mechanism is designed to improve network efficiency and reduce contention by allocating specific time slots for data transmission. It helps in managing the shared communication medium by preventing multiple stations from attempting to transmit simultaneously, thereby reducing collisions, and enhancing overall network performance. The TXOP is part of the medium access control (MAC) layer in the IEEE 802.11 standard and plays a crucial role in optimizing the utilization of the available wireless bandwidth.

Various embodiments can utilize MAPC Mode Selections. These MAPC modes can include a plurality of types that can be assigned to different coordination groupings. Frequency Division Multiple Access (FDMA) is a type of channelization protocol. In this setup, bandwidth is divided into various frequency bands. Each network device is allocated with a band to send data and that band is reserved for that particular network device for a specified time. The frequency bands of different network devices are separated by a small band of unused frequency-often referred to as guard bands-that can prevent the interference of other network devices.

Time Division Multiple Access (TDMA) is a channelization protocol in which the bandwidth of a channel is divided into various network devices on a time basis. There is a time slot given to each network device, which can transmit data during that time slot. Each network device should be aware of its time slot beginning and the location of the time slot. TDMA often relies on synchronization between the different network devices.

Co-TDMA enables a TXOP-holding device, more typically an AP, to share a portion of its TXOP with another nearby device, also typically an AP, which have commensurate priorities for medium time. Coordinated restricted target wake time (Co-RTWT) enables a first AP and its RTWT-capable associated STAs to make way for each burst of periodic traffic at a nearby cochannel BSS (i.e., the first AP and its STAs ensure their TXOPs do not overlap the scheduled start of each burst of the periodic traffic). Coordinated spatial reuse (Co-SR) is based on pathloss isolation and enables a first TXOP holding 802.11 device, more typically an AP, to invite a third cochannel 802.11 device, again more typically an AP, that is towards the edge of the coverage range of the first AP to communicate with a fourth (set of) nearby device(s) at the same time as the first device communicates with a second (set of) nearby device(s). In other variations the first AP device might solicit both a second device and fourth device (typically APs) that are mutually well separated to each communicate with a third (set of) device(s) and a fifth (set of) device(s) that are respectively nearby the second and fourth devices. Coordinated beamforming (Co-BF) is based on signal processing for beamforming and nullsteering to ensure that desired signals are received at high signal strength and undesired signals are received at a greatly lower level. Co-BF enables a first TXOP holding 802.11 device, more typically an AP, to invite a third cochannel 802.11 device, again more typically an AP to communicate with a fourth (set of) nearby device(s) at the same time as the first device communicates with a second (set of) nearby device(s), wherein the first and third devices use beamforming towards the second and fourth (set of) devices respectively and furthermore the first and third devices use nullsteering towards the fourth and second (set of) devices respectively. Coordinated FDMA (Co-FDMA) is akin to FDMA but with different transmitters (or groups of transmitters) agreeing on how to allocate a channel's bandwidth resources for a portion of time, without requiring orthogonality; and typically, a guard band is allocated between the two subband allocations for the two (groups of) transmitters. Coordinated OFDMA (Co-OFDMA) is akin to OFDMA but with different transmitters sending different data within different portions of a PPDU's bandwidth, with orthogonality or substantial orthogonality between the transmitters'transmissions. For each coordination group, the optimal MAPC mode among a set of MAPC modes (such as one more of coordinated TDMA, coordinated restricted target wake time, coordinated spatial reuse (Co-SR), coordinated beamforming (Co-BF), coordinated FDMA (Co-FDMA), coordinated OFDMA (Co-OFDMA), etc.) to use during the predicted high congestion period can be selected by evaluating the expected traffic classifications and congestion levels against a decision tree model trained on data from simulations. In certain embodiments, a decision tree model can predict the highest performing MAPC mode given the characteristics of the traffic predicted by the forecasting module. The decision tree model may use rules evaluating factors like number of clients, end devices capabilities, expected congestion levels, prevalent traffic types (burst/streaming), impact of congestion on QoS requirements, and/or the number of high-bandwidth clients.

In particular, Co-FDMA may be used to dynamically change the bandwidth of the channel in accordance with the neighboring channel allocation/spacing established by radio resource management (RRM). A shift in demand can be met by reducing the channel width of neighboring APs while simultaneously increasing the channel width (i.e., with Co-FDMA) of the one or more APs associated with the higher demand.

Additional embodiments can utilize predictive RT-DBS activation. The expected traffic volume time series data is evaluated by the system to determine periods of exceptionally high bandwidth demand where using RT-DBS would be beneficial. For the APs forecasted to encounter heavy congestion due to many high-bandwidth clients based on the predictive optimization, the system proactively triggers targeted activation of RT-DBS for that AP during that high demand period.

RT-DBS can allow the AP to temporarily increase its bandwidth to, e.g., 80/160/320 MHz, e.g., from a baseline bandwidth of say 20/40/80/160 MHz to support very high throughput. Shorter 20-40 millisecond (ms) RT-DBS transmissions are staggered between CGs and interlaced with regular TXOPs to avoid interference. Other modes are possible too: e.g. a short RT-DBS burst followed by a long non-RT-DBS burst; or a long RT-DBS burst followed by a long non-RT-DBS burst, where “long” is measured in seconds or minutes. The MAPC controller (i.e., for Co-FDMA) may coordinate the RT-DBS activation across APs using the following control channel handshake between the MAPC controller, APs and devices: (i) MAPC controller to AP (Pre-allocate RT-DBS TXOP), (ii) AP to device (Confirm new BWs for a number “n” of upcoming TXOPs), (iii) AP to MAPC controller (Confirm proposed RT-DBS TXOP schedule), and (iv) MAPC controller to AP (Commit RT-DBS TXOP). Some steps may be omitted or collapsed together (e.g., steps i+iv then ii and in parallel iii).

In certain embodiments, closed loop optimization can be utilized. As the system runs, real-time metrics can be collected on usage, throughput, latency and congestion from the APs and clients. This real-time feedback data can be fed into a Q-learning based reinforcement learning controller that continuously tunes parameters (e.g., key performance indicators (KPIs) related to network efficiency, congestion and QoS).

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits, gate arrays, or off-the-shelf semiconductors such as logic chips, transistors, or other discrete components. A function may also be implemented in programmable hardware devices such as field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

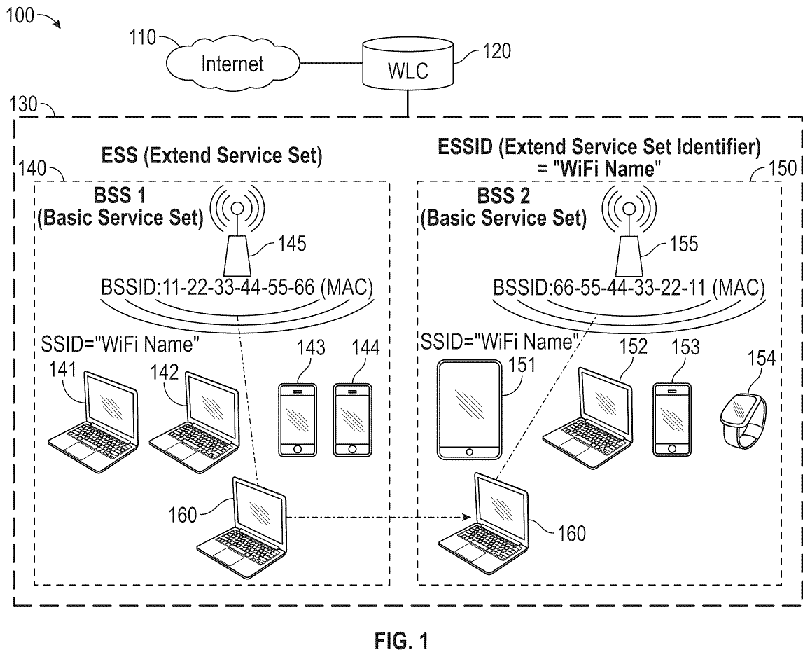

FIG. 1 illustrates a schematic block diagram of a wireless local networking system 100, according to certain embodiments. Wireless local networking standards play a crucial role in enabling seamless communication and connectivity between various devices within localized areas. One of the most prevalent standards is Wi-Fi, which is based on the IEEE 802.11 family of protocols. Wi-Fi provides high-speed wireless access to the internet and local network resources, with iterations such as 802.11a, 802.11b, 802.11 g, 802.11n, 802.11ac, 802.11ax and 802.11be, each offering improvements in speed, range, and efficiency. Each new connectivity generation of Wi-Fi is often designed to bring enhanced performance, increased capacity, and better efficiency in crowded network environments. One ingredient to achieve increased speed is to use a wider bandwidth, and this change is synergistic with increasing ranging accuracy, since the wider bandwidth enables the easier measurement of a finer time resolution. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of the IEEE 802.11 wireless local area networking standard and its amendments, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It is to be noted that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

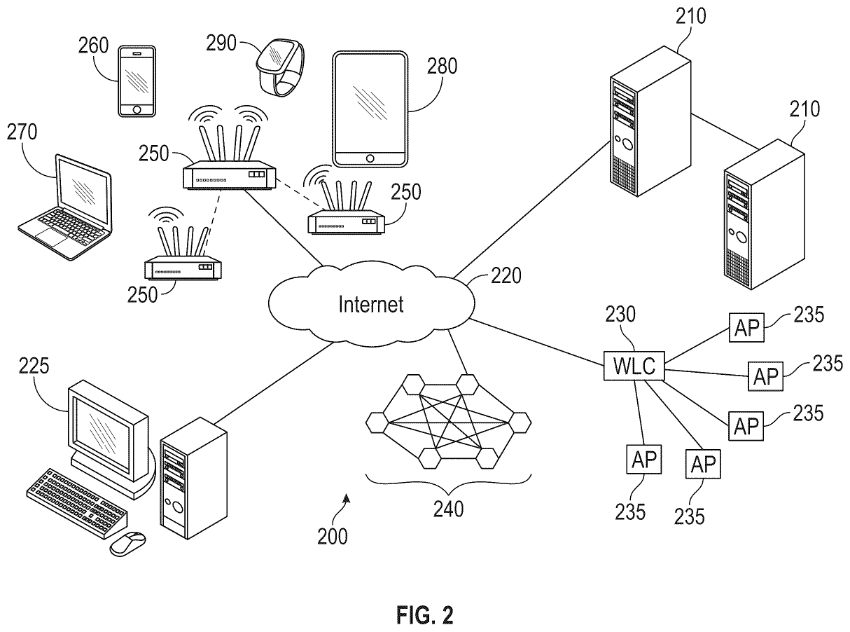

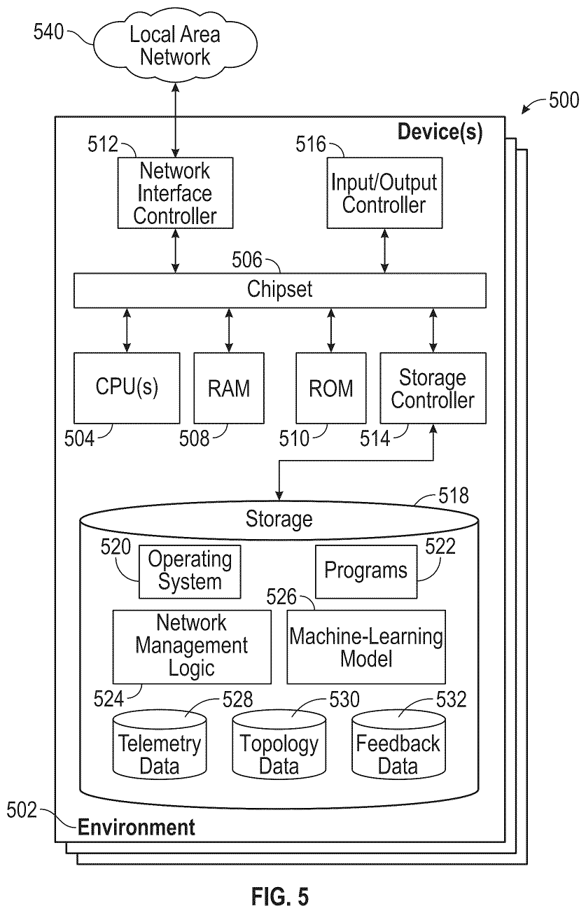

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 5, various devices on a network can include components such as a processor, transceiver, user interface, etc. These components can be configured to process frames of data transmitted and/or received over the wireless network. APs are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “Wi-Fi Name,” which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of the disclosed embodiments as required to realize a particularly desired embodiment.

FIG. 2 illustrates a conceptual network diagram 200 of various environments that a network management logic may operate on a plurality of network devices, according to certain embodiments. Those skilled in the art will recognize that the network management logic can include various hardware and/or software deployments and can be configured in a variety of ways. In many embodiments, the network management logic can be configured as a standalone device, exist as a logic in another network device, be distributed among various network devices operating in tandem, remotely operated as part of a cloud-based network management tool, or implemented in a computing device (e.g., a AP or controller). In further embodiments, one or more servers 210 can be configured with the network management logic or can otherwise operate as the networking logic. In many embodiments, the network management logic may operate on one or more servers 210 connected to a communication network 220 (shown as the “Internet”). The communication network 220 can include wired networks or wireless networks. The network management logic can be provided as a cloud-based service that can service remote networks, such as, but not limited to a deployed network 240.

However, in additional embodiments, the network management logic may be operated as a distributed logic across multiple network devices. In the embodiment depicted in FIG. 2, a plurality of network access points (APs) 250 can operate as the network management logic in a distributed manner or may have one specific device operate as the network management logic for all of the neighboring or sibling APs 250. The APs 250 may facilitate Wi-Fi connections for various electronic devices, such as but not limited to, mobile computing devices including laptop computers 270, cellular phones 260, portable tablet computers 280 and wearable computing devices 290.

In further embodiments, the network management logic may be integrated within another network device. In the embodiment depicted in FIG. 2, a wireless LAN controller (WLC) 230 may have an integrated network management logic that the WLC 230 can use to monitor or control power consumption of the APs 235 that the WLC 230 is connected to, either wired or wirelessly. In still more embodiments, a personal computer 225 may be utilized to access and/or manage various aspects of the networking logic, either remotely or within the network itself. In the embodiment depicted in FIG. 2, the personal computer 225 communicates over the communication network 220 and can access the network management logic of the servers 210, or the network APs 250, or the WLC 230. In many embodiments, the WLC 230 may be configured as a MAPC coordinator.

Although a specific embodiment for various environments that the network management logic may operate on a plurality of network devices suitable for carrying out the various steps, processes, methods, and operations described herein is discussed with respect to FIG. 2, any of a variety of systems and/or processes may be utilized in accordance with embodiments of the disclosure. In many non-limiting examples, the network management logic may be provided as a device or software separate from the WLC 230 or the network management logic may be integrated into the WLC 230. The elements depicted in FIG. 2 may also be interchangeable with other elements of the disclosed embodiments as required to realize a particularly desired embodiment.

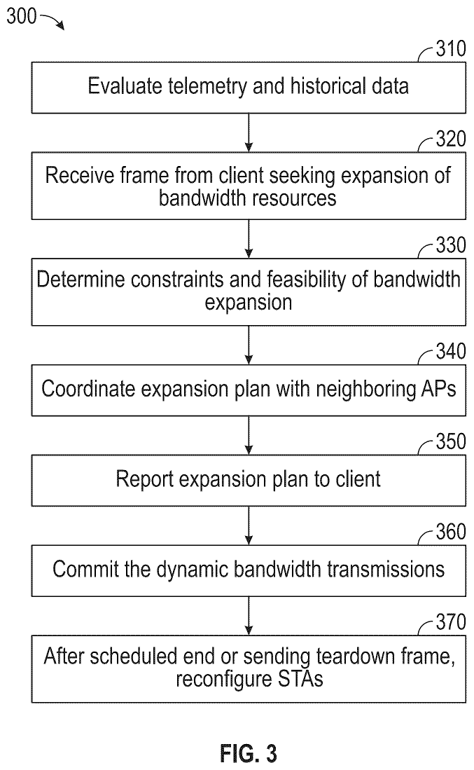

FIG. 3 is a flowchart depicting a process 300 for committing service-aware dynamic bandwidth transmissions, according to certain embodiments. In many embodiments, the process 300 can evaluate telemetry and historical data (block 310). Telemetry data, which may include real-time information on network parameters such as signal strength, bandwidth usage, and latency, among others, can provide immediate insights into the current state of the network. Historical data, on the other hand, can offer a broader perspective by capturing trends and patterns over time. Evaluating historical data may help predict usage patterns and allow for planning of capacity expansion. In certain embodiments, the use of advanced analytics tools and machine learning algorithms can further refine the evaluation process, providing more accurate predictions and actionable insights for efficient wireless network management.

In certain embodiments, the process 300 can detect that a client is seeking an expansion of bandwidth resources for a specific service (i.e., seeking wider bandwidth). Examples of specific services include high data rate infrastructure communications, more accurate ranging (arising from the more precise measurement of signal travel time when using wider bandwidth signals), etc. The client may send a management frame to an AP whose operating bandwidth is lower (e.g., 40/80 MHz) to indicate the client's interest in temporary bandwidth expansion services (block 320). The management frame may list the service(s) or requirements of the service(s). In some embodiments, the management frame optionally requests a duration/schedule for the bandwidth expansion service.

In certain embodiments, the process 300 determines constraints and the feasibility of bandwidth expansion (block 330). Determining constraints and feasibility of bandwidth expansion can involve several considerations and strategies. To determine whether there are any constraints and the feasibility of bandwidth expansion, the infrastructure, optionally in conjunction with clients, may perform measurements and inter-AP coordination to ascertain whether a bandwidth expansion process is feasible and under what constraints. Inter-AP coordination might operate as a function inside a centralized entity that is receiving metrics from the APs and performs coordination on behalf of said APs. In some embodiments, the infrastructure performs the measurements on an ongoing basis. Examples of feasibility and constraints include full bandwidth, a wider or slightly wider bandwidth, or adding some 20/40 MHz subchannel punctured for OBSS operation.

In some embodiments, the infrastructure constrains the bandwidth expansion service to a specific window or scheduled sequence of service periods (SPs)—e.g., a window available such as for the next 10 or 20 or 50 milliseconds, or a future window of time=Time (T) to (T+10 milliseconds), where there might be one window or a regular train of windows whose start times are each separated by a consistent period. For example, the process 300 can determine and select a plurality of dynamic bandwidth transmission opportunities. A wireless network can determine transmission opportunities through the utilization of various protocols such as, but not limited to, Carrier Sense Multiple Access with Collision Avoidance (CSMA/CA). These protocols can commonly be used in wireless communications to manage access to a shared communication medium, such as the airwaves. Before initiating a transmission, a device can listen to a channel to check for ongoing transmissions. If the channel is sensed as idle, the device assumes that it has a transmission opportunity and proceeds to transmit its data. However, if the channel is busy, the device can defer its transmission to avoid collisions. To further enhance collision avoidance, devices may employ additional techniques, such as “Request to Send/Clear to Send” (RTS/CTS). In these embodiments, a transmitting device can send a Request to Send frame, and if the receiving device is ready to accept the transmission, it responds with a Clear to Send frame, reserving the channel for the upcoming data transfer. In some embodiments, transmission opportunities may be determined by a regular schedule coordinated or set by the infrastructure, wherein the infrastructure alternates between wider bandwidth and lower bandwidth modes. However, as those skilled in the art will recognize, the use of additional methods can be made to schedule a plurality of transmission opportunities in the future, such as RTWT and/or Co-RTWT.

In certain embodiments, the process 300 notifies neighboring APs (i.e., in space and frequency) for coordination so the neighboring APs can avoid bandwidth expansion interference (block 340). In some embodiments, careful channel assignment may be considered, distributing access points across non-overlapping channels to minimize interference. Channel coordination mechanisms, such as Dynamic Frequency Selection (DFS) and Transmit Power Control (TPC), can help adapt channel usage dynamically based on environmental conditions. In some embodiments, logical groupings can be formed by configuring access points with the same Service Set Identifier (SSID), facilitating seamless client roaming. Identification and mitigation of interference sources, along with centralized management systems, may further enhance the coordination of multiple access points. Dynamic reconfiguration mechanisms can adapt to changes in the network environment, ensuring flexibility. Additionally, traffic engineering policies and consistent security configurations across the coordination group can contribute to a well-optimized and secure wireless network. The specific implementation may vary based on the wireless networking equipment, protocols, and technologies used in a particular environment.

In certain embodiments, the infrastructure reports the bandwidth expansion plan to the client in general terms (e.g., transmitting over the wider allowed bandwidth at allowed times) so the client can configure itself accordingly (block 350). For example, the infrastructure can generate a confirmation signal associated with the upcoming dynamic bandwidth transmission opportunities. This confirmation signal can be an agreement that the proposed schedule will be followed. The confirmation signal may be transmitted to a multi-access point coordinator. This confirmation signal can be added to one or more frames of data sent back and forth between an AP and a MAPC coordinator. However, in some embodiments, a confirmation signal may not be transmitted as the MAPC coordinator can assume that the schedule will be followed unless otherwise prompted.

In certain embodiments, the process 300 commits the dynamic bandwidth transmission outlined by the bandwidth expansion plan (block 360). Once approved, the network devices, such as a MAPC pairing or grouping of APs, can transmit data utilizing the proposed schedule and general terms (e.g. transmitting over the wider allowed bandwidth at allowed times). In many embodiments, this schedule is associated with a dynamic bandwidth switching mode. This dynamic bandwidth switching mode can occur during a plurality of transmission opportunities that were pre-allocated and/or pre-scheduled. As those skilled in the art will recognize, this can occur for a variable period of time based on various factors such as the amount of data that needs to be transferred, the current network conditions, potential interference, etc.

In certain embodiments, after a scheduled end or a teardown frame is sent to terminate the expansion of bandwidth resources, the STA reconfigures itself accordingly (block 370). For example, the STA may return the filter bandwidth back to the BSS bandwidth.

Although a specific embodiment for a process for committing dynamic bandwidth transmissions suitable for carrying out the various steps, processes, methods, and operations described herein is discussed with respect to FIG. 3, any of a variety of systems and/or processes may be utilized in accordance with embodiments of the disclosure. The elements depicted in FIG. 3 may also be interchangeable with other elements of the disclosed embodiments to realize a particularly desired embodiment.

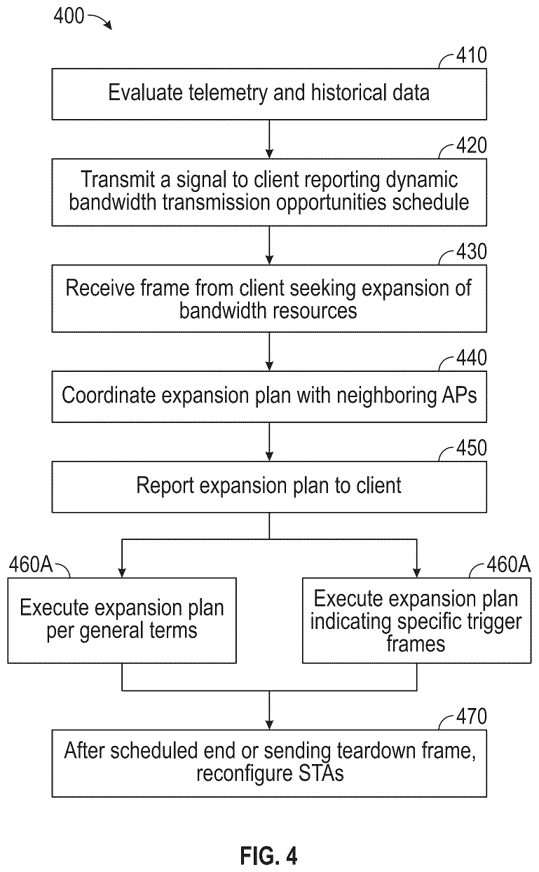

FIG. 4 is a flowchart depicting a process 400 for committing service-aware dynamic bandwidth transmissions under general terms or specific trigger frames, according to certain embodiments. In certain embodiments, the process 400 can evaluate telemetry and historical data (block 410). Telemetry data, which may include real-time information on network parameters such as signal strength, bandwidth usage, and latency, among others, can provide immediate insights into the current state of the network. Historical data, on the other hand, can offer a broader perspective by capturing trends and patterns over time. Evaluating historical data may help predict usage patterns and allow for planning of capacity expansion. In certain embodiments, the use of advanced analytics tools and machine learning algorithms can further refine the evaluation process, providing more accurate predictions and actionable insights for efficient wireless network management.

In certain embodiments, the infrastructure may send an unsolicited request to the client (e.g., if the request is an asset tag) reporting a dynamic bandwidth transmission opportunities schedule (block 420). In some embodiments, the request is in the form of an element in a beacon and/or probe response reporting a regular schedule of SPs during which the AP is in a wider bandwidth mode (e.g., a wider bandwidth broadcast target wake time (TWT) schedule). In this case, instead of waiting for the client to request bandwidth expansion (e.g., process 300) the infrastructure provides the client with a regular schedule of the service periods during which the AP is in a wider bandwidth mode to accommodate the data transfer of the client.

In certain embodiments, after reporting the bandwidth transmission opportunity schedule, the client may pre-schedule a transmission or specific service by requesting (e.g., sending a management frame to an AP) a time period in the bandwidth transmission opportunity schedule when the AP is operating at a wider bandwidth mode (block 430). The management frame may list the service(s) or requirements of the service(s). In some embodiments, the management frame optionally requests a duration/schedule for the bandwidth expansion service.

In certain embodiments, the infrastructure notifies neighboring APs (i.e., in space and frequency) for coordination during the time period requested by the client so the neighboring APs can avoid bandwidth expansion interference (block 440). In some embodiments, careful channel assignment may be considered, distributing access points across non-overlapping channels to minimize interference. Channel coordination mechanisms, such as Dynamic Frequency Selection (DFS) and Transmit Power Control (TPC), can help adapt channel usage dynamically based on environmental conditions. In some embodiments, logical groupings can be formed by configuring access points with the same Service Set Identifier (SSID), facilitating seamless client roaming. Identification and mitigation of interference sources, along with centralized management systems, may further enhance the coordination of multiple access points. Dynamic reconfiguration mechanisms can adapt to changes in the network environment, ensuring flexibility. Additionally, traffic engineering policies and consistent security configurations across the coordination group can contribute to a well-optimized and secure wireless network. The specific implementation may vary based on the wireless networking equipment, protocols, and technologies used in a particular environment.

In additional embodiments, the infrastructure reports the bandwidth expansion plan to the client in general terms (e.g. transmitting over the wider allowed bandwidth at allowed times) so the client can configure itself accordingly (block 450). For example, the infrastructure can generate a confirmation signal associated with the upcoming dynamic bandwidth transmission opportunities. This confirmation signal can be an agreement that the proposed schedule will be followed. The confirmation signal may be transmitted to a multi-access point coordinator. This confirmation signal can be added to one or more frames of data sent back and forth between an AP and a MAPC coordinator. However, in some embodiments, a confirmation signal may not be transmitted as the MAPC coordinator can assume that the schedule will be followed unless otherwise prompted.

In certain embodiments, the infrastructure executes the expansion plan and commits the dynamic bandwidth transmission outlined by the bandwidth expansion plan. In certain embodiments, this schedule is association with a dynamic bandwidth switching mode. This can occur during a plurality of transmission opportunities that were pre-allocated and/or pre-scheduled. As those skilled in the art will recognize, this can occur for a variable period of time based on various factors such as the amount of data that needs to be transferred, the current network conditions, potential interference, etc. Once approved, the network devices, such as a MAPC pairing or grouping of APs can execute the expansion plan utilizing the proposed schedule and general terms (e.g. transmitting over the wider allowed bandwidth at allowed times) (block 460A).

In some embodiments, the network devices execute the expansion plan utilizing the proposed schedule and/or further indicating specific trigger frames (block 460B). In such scenarios, the infrastructure sends the client specific trigger frames that specifically enable the client to use wider bandwidth for a specific service, or the specific service-related requested) in the physical layer protocol data units (PPDUs) immediately following the specific trigger frames. The trigger frames can use Preferred AC or something more specific like (Preferred) stream classification service (SCS) identification (ID), service ID, or ID of service request to identify the plan.

In certain embodiments, after a scheduled end or a teardown frame is sent to terminate the expansion of bandwidth resources, the STA reconfigures itself accordingly (block 470). For example, the STA may return the filter bandwidth back to the BSS bandwidth.

Although a specific embodiment for a process for committing dynamic bandwidth transmissions suitable for carrying out the various steps, processes, methods, and operations described herein is discussed with respect to FIG. 4, any of a variety of systems and/or processes may be utilized in accordance with embodiments of the disclosure. The elements depicted in FIG. 4 may also be interchangeable with other elements of the disclosed embodiments as required to realize a particularly desired embodiment.

FIG. 5 illustrates a conceptual block diagram of a device suitable for configuration with a network management logic, according to certain embodiments. The embodiment of the conceptual block diagram depicted in FIG. 5 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 5 can also illustrate an access point, a switch, or a router in accordance with various embodiments of the disclosure. The device 500 may, in many non-limiting examples, correspond to physical devices or to virtual resources described herein.

In many embodiments, the device 500 may include an environment 502 such as a baseboard or “motherboard,” in physical embodiments that can be configured as a printed circuit board with a multitude of components or devices connected by way of a system bus or other electrical communication paths. Conceptually, in virtualized embodiments, the environment 502 may be a virtual environment that encompasses and executes the remaining components and resources of the device 500. In more embodiments, one or more processors 504, such as, but not limited to, central processing units (“CPUs”) can be configured to operate in conjunction with a chipset 506. The processor(s) 504 can be standard programmable CPUs that perform arithmetic and logical operations necessary for the operation of the device 500.

In a number of embodiments, the processor(s) 504 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 506 may provide an interface between the processor(s) 504 and the remainder of the components and devices within the environment 502. The chipset 506 can provide an interface to a random-access memory (“RAM”) 508, which can be used as the main memory in the device 500 in some embodiments. The chipset 506 can further be configured to provide an interface to a computer-readable storage medium such as a read-only memory (“ROM”) 510 or non-volatile RAM (“NVRAM”) for storing basic routines that can help with various tasks such as, but not limited to, starting up the device 500 and/or transferring information between the various components and devices. The ROM 510 or NVRAM can also store other application components necessary for the operation of the device 500 in accordance with various embodiments described herein.

Additional embodiments of the device 500 can be configured to operate in a networked environment using logical connections to remote computing devices and computer systems through a network, such as the network 540. The chipset 506 can include functionality for providing network connectivity through a network interface card (“NIC”) 512, which may comprise a gigabit Ethernet adapter or similar component. The NIC 512 can be capable of connecting the device 500 to other devices over the network 540. It is contemplated that multiple NICs 512 may be present in the device 500, connecting the device to other types of networks and remote systems.

In further embodiments, the device 500 can be connected to a storage 518 that provides non-volatile storage for data accessible by the device 500. The storage 918 can, for instance, store an operating system 520, applications 522. The storage 518 can be connected to the environment 502 through a storage controller 514 connected to the chipset 906. In certain embodiments, the storage 518 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 500 can store data within the storage 518 by transforming the physical state of the physical storage units to reflect the information being stored. The specific transformation of physical state can depend on various factors. Examples of such factors can include, but are not limited to, the technology used to implement the physical storage units, whether the storage 518 is characterized as primary or secondary storage, and the like.

In many more embodiments, the device 500 can store information within the storage 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 500 can further read or access information from the storage 518 by detecting the physical states or characteristics of one or more particular locations within the physical storage units.

In addition to the storage 518 described above, the device 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 500. In some examples, the operations performed by a cloud computing network, and any components included therein, may be supported by one or more devices similar to device 500. Stated otherwise, some or all of the operations performed by the cloud computing network, and any components included therein, may be performed by one or more devices 500 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 518 can store an operating system 520 utilized to control the operation of the device 500. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 518 can store other system or application programs and data utilized by the device 500.

In many additional embodiments, the storage 518 or other computer-readable storage media is encoded with computer-executable instructions which, when loaded into the device 500, may transform it from a general-purpose computing system into a special-purpose computer capable of implementing the embodiments described herein. These computer-executable instructions may be stored as application 522 and transform the device 500 by specifying how the processor(s) 504 can transition between states, as described above. In some embodiments, the device 500 has access to computer-readable storage media storing computer-executable instructions which, when executed by the device 500, perform the various processes described above. In certain embodiments, the device 500 can also include computer-readable storage media having instructions stored thereupon for performing any of the other computer-implemented operations described herein.

In many further embodiments, the device 500 may include a network management logic 524. The network management logic 524 can be configured to perform one or more of the various steps, processes, operations, and/or other methods that are described above. Often, the network management logic 524 can be a set of instructions stored within a non-volatile memory that, when executed by the processor(s)/controller(s) 504 can carry out these steps, etc. In some embodiments, the network management logic 524 may be a client application that resides on a network-connected device, such as, but not limited to, a server, switch, personal or mobile computing device in a single or distributed arrangement.

In some embodiments, telemetry data 528 can encompass real-time measurements crucial for monitoring and optimizing network performance. It may include details like bandwidth usage, latency, packet loss, and error rates, providing insights into data transmission quality and identifying potential issues. Telemetry data 528 may also cover traffic patterns and application performance, support capacity planning and ensuring optimal user experience. The collection and analysis of this data are essential for proactive network management, facilitated by advanced monitoring tools and technologies. In further embodiments, the telemetry data 528 can include historical data related to past network activity.

In various embodiments, topology data 530 can comprise information detailing the physical or logical arrangement of network devices and their interconnections. This data can provide insights into the structure of the network, including the relationships between routers, switches, servers, and other components. Topology data 530 can describe the actual layout of devices, such as their placement in a building or across multiple locations, while logical topology data may focus on the communication paths and relationships between devices regardless of their physical location. Understanding network topology is crucial for troubleshooting, optimizing performance, and planning for scalability. It can enable network administrators to identify potential points of failure, ensure efficient data flow, and make informed decisions about network expansion or reconfiguration. Advanced tools and technologies are often employed to visualize and analyze topology data 530, aiding in the effective management and maintenance of complex network infrastructures.

In a number of embodiments, feedback data 532 may comprise detailed information about processes, individual devices, and/or applications connected to the network. This data can include, for example, unique identifiers known as MAC addresses assigned to each wireless device, indicating their presence on the network and any data associated with them such that parsing of the feedback data 532 is possible on a granular level. Feedback data 532 can encompass the current connection status of each device, indicating whether it is actively connected or not, and how any process is currently going. Additionally, it can provide insights into signal strength, offering information about the quality of the wireless connection as well as data usage metrics which can specify the amount of data transmitted and received by each device. In more embodiments, the feedback data 532 can include monitoring data crucial for network administrators or management logics to optimize network performance, troubleshoot connectivity issues, and manage resources effectively, providing a comprehensive view of the devices interacting within the wireless environment. Advanced network management tools can offer real-time insights into station data, empowering administrators to make informed decisions regarding network optimization and security.

In still further embodiments, the device 500 can also include one or more input/output controllers 516 for receiving and processing input from a number of input devices, such as a keyboard, a mouse, a touchpad, a touch screen, an electronic stylus, or other type of input device. Similarly, an input/output controller 516 can be configured to provide output to a display, such as a computer monitor, a flat panel display, a digital projector, a printer, or other type of output device. Those skilled in the art will recognize that the device 500 might not include all of the components shown in FIG. 5 and can include other components that are not explicitly shown in FIG. 5 or might utilize an architecture completely different than that shown in FIG. 5.

As described above, the device 500 may support a virtualization layer, such as one or more virtual resources executing on the device 500. In some examples, the virtualization layer may be supported by a hypervisor that provides one or more virtual machines running on the device 500 to perform functions described herein. The virtualization layer may generally support a virtual resource that performs at least a portion of the techniques described herein.

Finally, in numerous additional embodiments, data may be processed into a format usable by a machine-learning model 526 (e.g., feature vectors), and other pre-processing techniques. The machine-learning (“ML”) model 526 may be any type of ML model, such as supervised models, reinforcement models, and/or unsupervised models. The ML model 526 may include one or more of linear regression models, logistic regression models, decision trees, Naïve Bayes models, neural networks, k-means cluster models, random forest models, and/or other types of ML models 526.

The ML model(s) 526 can be configured to generate inferences to make predictions or draw conclusions from data. An inference can be considered the output of a process of applying a model to new data. This can occur by learning from at least the telemetry data 528, the power topology data 530, and the feedback data 532. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 526 may be generated by human/administrator verifications or may compare predicted outcomes with actual outcomes.

Although a specific embodiment for a device suitable for configuration with the network management logic for carrying out the various steps, processes, methods, and operations described herein is discussed with respect to FIG. 5, any of a variety of systems and/or processes may be utilized in accordance with embodiments of the disclosure. For example, the device 500 may be in a virtual environment such as a cloud-based network administration suite, or it may be distributed across a variety of network devices or APs. The elements depicted in FIG. 5 may also be interchangeable with other elements of the disclosed embodiments as required to realize a particularly desired embodiment.

### Example Clauses

Implementation examples are described in the following numbered clauses:
Clause 1: A computer-implemented method for managing at least one client station (STA) within a wireless network, the computer-implemented method performed by a computing device and comprising receiving a request from, or anticipating a request by, the at least one STA for an expansion of bandwidth resources; determining constraint and feasibility of the expansion of bandwidth resources, based on target parameters; and expanding bandwidth resources of at least one access point of one or more access points within the wireless network.
Clause 2: The computer-implemented method of clause 1, wherein the request comprises a management frame, and wherein the request lists one or more target parameters for a service of the at least one STAs.
Clause 3: The computer-implemented method of clause 2, wherein the service comprises a high data rate infrastructure communication.
Clause 4: The computer-implemented method of clause 1, wherein the request comprises a request to expand bandwidth resources for a time period, wherein the request is part of a 802.11 stream classification service (SCS) quality of service (QoS) characteristic (QC) or a target wake time (TWT) mechanism.
Clause 5: The computer-implemented method of clause 1, wherein the request comprises a request for a schedule of future dynamic bandwidth transmission opportunities.
Clause 6: The computer-implemented method of clause 1, wherein an access point receiving the request is currently operating at a low bandwidth mode.
Clause 7: The computer-implemented method of clause 1, wherein the method further comprises transmitting a dynamic bandwidth transmission opportunities schedule to the at least one STA prior to receiving the request.
Clause 8: The computer-implemented method of clause 7, wherein the dynamic bandwidth transmission opportunities schedule indicates time periods that the at least one access point is operating at a wider bandwidth mode, wherein the at least one access point services the request.
Clause 9: The computer-implemented method of clause 8, wherein the at least one access point serving the request returns to operating a low bandwidth mode in between the time periods that the access point is operating at the wider bandwidth mode.
Clause 10: The computer-implemented method of clause 1, wherein the method further comprises coordinating the expansion of bandwidth resources among one or more access points within the wireless network to minimize interference.
Clause 11: A computer-implemented method for wireless communications performed by a first access point (AP) of a plurality of APs, the computer-implemented method comprising transmitting a schedule to a client station (STA) to indicate bandwidth transmission opportunities, wherein bandwidth transmission opportunities are time periods that the first AP is operating at a wide bandwidth mode; receiving a request from the STA to perform services during bandwidth transmission opportunities responsive to transmitting the schedule; coordinating an expansion of bandwidth resources between neighboring APs of the plurality of APs relative to the first AP; and expanding bandwidth resources of the first AP according to the schedule, wherein the first AP is the AP that services the STA.
Clause 12: The computer-implemented method of clause 11, wherein the transmitting of the schedule is unsolicited by the STA.
Clause 13: The computer-implemented method of clause 11, wherein the transmitting comprises transmitting a beacon frame.
Clause 14: The computer-implemented method of clause 11, wherein the services are performed during bandwidth transmission opportunities.
Clause 15: The computer-implemented method of clause 14, wherein the services are performed via transmitting one or more trigger frames.
Clause 16: The computer-implemented method of clause 15, wherein the one or more trigger frames utilize stream classification service (SCS) identification (ID).
Clause 17: The computer-implemented method of clause 15, wherein the one or more trigger frames utilize service identification (ID).
Clause 18: A first access point (AP) multilink device (MLD) comprising one or more memories collectively storing instructions; and one or more processors communicatively coupled to the one or more memories, the one or more processors being individually or collectively configured to execute the instructions to cause the first AP MLD to perform an operation comprising transmitting a schedule to a client station (STA) to indicate bandwidth transmission opportunities, wherein bandwidth transmission opportunities are time periods that the first AP is operating at a wide bandwidth mode; receiving a request for an expansion of bandwidth resources from the STA, wherein the request lists one or more target parameters associated with a service being performed by the STA; coordinating an expansion of bandwidth resources between neighboring APs relative to the first AP; and expanding bandwidth resources of the first AP, wherein the first AP is the AP that services the STA.
Clause 19: The first AP MLD of clause 19, wherein the request comprises a request to pre-schedule performing the service during bandwidth transmission opportunities.
Clause 20: The first AP MLD of clause 19, wherein the service is performed via transmitting one or more trigger frames which utilize stream classification service (SCS) identification (ID) or service identification (ID).

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions, or multiple memories configured to collectively store data and/or instructions.

In the current disclosure, reference is made to various embodiments. However, the scope of the present disclosure is not limited to specific embodiments described. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method for managing at least one client station (STA) within a wireless network, the computer-implemented method performed by a computing device and comprising:
receiving a request from, or anticipating a request by, the at least one STA for an expansion of bandwidth resources;
determining constraint and feasibility of the expansion of bandwidth resources, based on target parameters; and
expanding bandwidth resources of at least one access point of one or more access points within the wireless network.

2. The computer-implemented method of claim 1, wherein the request comprises a management frame, and wherein the request lists one or more target parameters for a service of the at least one STAs.

3. The computer-implemented method of claim 2, wherein the service comprises a wide bandwidth ranging communication.

4. The computer-implemented method of claim 1, wherein the request comprises a request to expand bandwidth resources for a time period, wherein the request is part of a 802.11 stream classification service (SCS) quality of service (QoS) characteristic (QC) or a target wake time (TWT) mechanism.

5. The computer-implemented method of claim 1, wherein the request comprises a request for a schedule of future dynamic bandwidth transmission opportunities.

6. The computer-implemented method of claim 1, wherein an access point receiving the request is currently operating at a low bandwidth mode.

7. The computer-implemented method of claim 1, wherein the method further comprises transmitting a dynamic bandwidth transmission opportunities schedule to the at least one STA prior to receiving the request.

8. The computer-implemented method of claim 7, wherein the dynamic bandwidth transmission opportunities schedule indicates time periods that the at least one access point is operating at a wider bandwidth mode, wherein the at least one access point services the request.

9. The computer-implemented method of claim 8, wherein the at least one access point serving the request returns to operating a low bandwidth mode in between the time periods that the access point is operating at the wider bandwidth mode.

10. The computer-implemented method of claim 1, wherein the method further comprises coordinating the expansion of bandwidth resources among one or more access points within the wireless network to minimize interference.

11. A computer-implemented method for wireless communications performed by a first access point (AP) of a plurality of APs, the computer-implemented method comprising:
transmitting a schedule to a client station (STA) to indicate bandwidth transmission opportunities, wherein bandwidth transmission opportunities are time periods that the first AP is operating at a wide bandwidth mode;
receiving a request from the STA to perform services during bandwidth transmission opportunities responsive to transmitting the schedule;
coordinating an expansion of bandwidth resources between neighboring APs of the plurality of APs relative to the first AP; and
expanding bandwidth resources of the first AP according to the schedule, wherein the first AP is the AP that services the STA.

12. The computer-implemented method of claim 11, wherein the transmitting of the schedule is unsolicited by the STA.

13. The computer-implemented method of claim 11, wherein the transmitting comprises transmitting a beacon frame.

14. The computer-implemented method of claim 11, wherein the services are performed during bandwidth transmission opportunities.

15. The computer-implemented method of claim 14, wherein the services are performed via transmitting one or more trigger frames.

16. The computer-implemented method of claim 15, wherein the one or more trigger frames utilize stream classification service (SCS) identification (ID).

17. The computer-implemented method of claim 15, wherein the one or more trigger frames utilize service identification (ID).

18. A first access point (AP) multilink device (MLD) comprising:
one or more memories collectively storing instructions; and
one or more processors communicatively coupled to the one or more memories, the one or more processors being individually or collectively configured to execute the instructions to cause the first AP MLD to perform an operation comprising:
transmitting a schedule to a client station (STA) to indicate bandwidth transmission opportunities, wherein bandwidth transmission opportunities are time periods that the first AP is operating at a wide bandwidth mode;
receiving a request for an expansion of bandwidth resources from the STA, wherein the request lists one or more target parameters associated with a service being performed by the STA;
coordinating an expansion of bandwidth resources between neighboring APs relative to the first AP; and
expanding bandwidth resources of the first AP, wherein the first AP is the AP that services the STA.

19. The first AP MLD of claim 18, wherein the request comprises a request to pre-schedule performing the service during bandwidth transmission opportunities.

20. The first AP MLD of claim 18, wherein the service is performed via transmitting one or more trigger frames which utilize stream classification service (SCS) identification (ID) or service identification (ID).
